(19) United States
(12) Patent Application Publication
(10) Pub. No.: US 2026/0326075 A1
(43) Pub. Date: Oct. 22, 2026

(54) PHOTOREACTORS

(71) Applicant: Karlsruher Institut für Technologie, Karlsruhe (DE)

(72) Inventors: Paul KANT, Karlsruhe (DE); Michael RUBIN, Karlsruhe (DE); Roland DITTMEYER, Karlsruhe (DE); Geoffrey Alan OZIN, Toronto (CA)

(21) Appl. No.: 19/111,188

(22) PCT Filed: Sep. 11, 2023
(86) PCT No.: PCT/EP2023/074842

§ 371 Date: Mar. 12, 2025

(30) Foreign Application Priority Data
Sep. 12, 2022 (DE) 102022123109.7

(51) Int. Cl. B01J 19/12

(52) U.S. Cl. CPC B01J 19/127; B01J 2219/00243; B01J 2219/19

(57) ABSTRACT

The present invention relates to photoreactors, in particular for sun-supported photosynthesis, comprising a concentrator and a cavity, in particular configured as a flow-through reactor, wherein the cavity has a deformation such that the beam reflected from the point of incidence is not directly reflected out of the cavity again.

All documents cited in the present application are incorporated by reference in their entirety into the present disclosure.

The present invention relates to photoreactors, in particular for sun-supported photosynthesis, comprising a concentrator and an optical cavity, configured in particular as a flow-through reactor, wherein the optical cavity has a geometry such that the beam reflected from the point of incidence is not reflected directly out of the cavity again.

Photoreactors are known from the prior art. There are different designs, e.g. panel-type photoreactors without significant manipulation of the incident light or concentrating photoreactors that concentrate incident light using optical components before it is coupled into the reaction volume. The latter typically comprise a concentrator that is used to collect the light and an optical cavity into which the collected light is directed and which forms the reaction volume. The optical cavities can have a wide variety of shapes, for example tubular shape. The concentrators can also have a wide variety of shapes, but it must be ensured that the collected light is directed into the optical cavity. For example, the concentrators can be parabolic mirrors that reflect the light into the optical cavity in a concentrated manner; in this case, for example, the focus of the light beams is at the entrance to the optical cavity.

EP 1 848 528 B1 describes a panel-type photoreactor that resembles a tube bundle consisting of a plurality of parallel glass tubes. The wall thickness of the glass tubes is chosen to be ‘high’ (at least 10% of the inner diameter) so that light falling on one side of the tube bundle also hits deeper tubes. In addition to the function of guiding the fluid, the tube walls thus have the object of ‘optical’ dilution. The tubes are arranged in the bundle in such a way that a panel-like overall structure results. It is argued that the proposed arrangement also offers advantages with regard to light scattering in the reaction zone. Scattered light from one of the tubes would, with great probability, hit the reaction zone in one of the adjacent tubes in that system. This would ensure sufficient photocatalytic efficiency. To avoid ‘self-shadowing’ of the reaction zone through intense light absorption and/or scattering, the inner diameter of the tubes had to be less than 10 mm. The concept of EP 1 848 528 B1 addresses the challenge of scattering losses by a suitable arrangement of several reaction zones next to each other. However, this is done with a considerable amount of material. A large number of glass tubes have to be arranged next to each other and be fluidly connected. To meet the challenge of optically connecting larger catalyst volumes, the use of thick-walled glass tubes is proposed, which further reinforces the argument of the material costs. Furthermore, the arrangement of ‘parasitic’ absorbing volumes—in the case of EP 1 848 528 B1 large glass volumes—in the illuminated reaction volume always leads to absorption losses, which should be avoided.

EP 2 194 117 A1 discloses a channel-like photoreactor which is characterised by a trapezoidal cross-section. The cross-section is proposed to ensure homogeneous illumination of the reaction zone in photoreactions. The application focus in EP 2 194 117 A1 is on biological photosynthesis by algae.

From an economic point of view, photosynthesis, especially in the case of photosynthesis of energy carriers, can only be useful if a sufficient photocatalytic efficiency is achieved and the reaction technology used can be applied cost-effectively to large areas. To maintain economic efficiency in the synthesis of energy carriers, an energy efficiency of at least 5-10% seems reasonable. This value would be similar to the system efficiency achieved by technically more advanced power-to-fuel technologies (electricity-based synthetic chemical energy carriers).

Based on the known state of the art, there is still further potential for improvement. In particular, the degree of utilisation of the incident light or the radiation transport efficiency from the photoreactor aperture into the reaction volume, as well as the use of materials in the construction of photoreactors for sun-supported photosynthesis, is still in need of improvement.

The object of the present invention was therefore to provide photoreactors that are improved with respect to the prior art, that avoid the disadvantages of the prior art and that can achieve particularly good results while at the same time using less material.

Further objects arise for the person of ordinary skill in the art from the following description.

These and other objects are solved in the context of the present invention by the subject matter of the independent claims.

Preferred embodiments arise from the dependent claims as well as the following description.

In the context of the present invention, the term ‘comprising’ includes, in each case, ‘consisting of’ as a particularly preferred embodiment; that is, in addition to the explicitly mentioned elements, a corresponding list may also contain (=comprise) further elements, or it may contain exactly these elements (=consist of) (whereby insignificant elements such as screws, markings, etc. are not taken into account).

In the case of relative indications such as above, below, left, right or similar, the present invention is based on the reference system of an observer standing upright on the ground in front of the object under discussion.

In the context of the present invention, the term ‘and/or’ means that both elements mentioned in the context are each included individually as well as the combination of the elements mentioned in the context.

In the context of the present invention, all quantities are to be understood as weight quantities, unless otherwise indicated.

In the context of the present invention, the term ‘ambient temperature’ refers to a temperature of 20° C. Unless otherwise indicated, temperature values are in degrees Celsius (° C.).

Unless otherwise indicated, the reactions and process steps are carried out at atmospheric pressure, i.e. at about 1013 kPa.

In the context of the present invention, the term ‘aperture width’ (or aperture width of the concentrator or line concentrator (also given as d1) means the distance between the layers of the two legs of the concentrator that reflect the incident light (in the case of reflective metallic surfaces, therefore, between the two inner sides, in the case of transparent surfaces coated on one side with a reflective coating, between the coated sides) at the location of the concentrator with the widest cross-section, i.e. at the end of the concentrator furthest from the cavity.

In the context of the present invention, the term ‘width of the entrance to the cavity’ (also given as d2) means the distance between the layers of the two legs of the concentrator that reflect the incoming light ((in the case of reflective metallic surfaces, therefore, between the two inner sides, in the case of transparent surfaces coated on one side with a reflective coating, between the coated sides) at the opening to the cavity (at the location where the concentrator and cavity are connected to one another).

In the context of the present invention, the term ‘length of the concentrator’ (also given as d4) refers to the height of the concentrator sides, measured from the uppermost tip of the layer reflecting the incoming light to the point of contact of the layer reflecting the incoming light with the outer wall of the cavity.

In the context of the present invention, the term ‘diameter of the cavity’ (also given as d3) means the inner diameter of the cavity, i.e. the width measured at the widest position of the cavity between the inner walls of the cavity, in the case of an ellipsoidal configuration, the largest inner diameter.

In the context of the present invention, the term ‘wall thickness of the transparent material’ (also given as d5) means the thickness of the walls of the concentrator or of the cavity, if the walls consist of optically transparent material (for the incident light beams, i.e. their wavelengths (in whole or in part)), and are preferably reflective (reflectively coated) on the outside.

Generally speaking, the present invention relates to a photoreactor design that can be used in particular for sun-supported photosynthesis, e.g. for the production of energy carriers from CO2 and water, or for water treatment. Accordingly, the present invention is also in the field of reaction engineering.

A particular subject of the present invention is a photoreactor, in particular for sun-supported photosynthesis, configured in particular as a flow-through reactor, comprising a concentrator and a cavity, wherein the concentrator, viewed in the flow direction, has a V-shaped cross-section open at the bottom (i.e. at the attachment with the cavity), or is designed as a compound parabolic concentrator (CPC), which is in direct contact with the cavity at its lower end and forms an entrance area to the cavity there, and has
an aperture width d1,
a width of the entrance to the cavity d2 and
a length d4;

the cavity inner wall, viewed in the direction of flow, has an ellipsoidal, preferably circular, cross-section with a diameter d3, which, in the area of incidence of the primary incident light beam, has at least one deformation of such a kind that the light beam reflected from the point of incidence is not reflected directly out of the cavity again;
and wherein
(1) the ratio of d1 to d2 is in a range of 2 to 3,
(2) the ratio of d4 to d1 is in a range of 0.5 to 2.5.

Optionally,
(3) a for a configuration as a single photoreactor, d1 is smaller than d3 or equal to d3, and
(3)b for a configuration as one of several interconnected photoreactors (as a photoreactor array), d1 is greater than d3.

In this context, it should be noted that a single photoreactor can, of course, be constructed/arranged in close proximity to several other photoreactors. Single reactor simply means that the reactors are not connected to each other, but rather each is operated independently and the cavities do not form a connected flow channel.

The concentrator legs in the variant with a V-shaped cross-section do not have to be straight throughout, but can be curved over their entire length or partially, independently of each other. The curvature depends on the location and incidence of light and can easily be adapted by a person of ordinary skill in the art based on his knowledge in the art. In a preferred embodiment of the present invention, the curvature corresponds to that of a compound parabolic concentrator (CPC).

In the context of the present invention, a compound parabolic concentrator (CPC) is understood to be a reflective, non-imaging optical device that uses specially configured parabolic properties to exploit the maximum concentration of light energy. The wide (upper or turned away from the cavity) end of the CPC collects divergent light or light that comes from different directions of incidence during the course of the day, which is then reflected in the CPC and concentrated at the narrow (lower or cavity-facing) output end or in the cavity. CPCs are defined by an acceptance angle that indicates the angular range in which the CPC can collect light. In this respect, a CPC within the scope of the present invention can be considered a variant derived from the V-shaped cross-section, in which the legs are not straight but curved.

In the context of the present invention, the term ‘ellipsoidal, preferably circular, cross-section’ means that the inner wall, apart from the at least one deformation, corresponds to an ellipse (i.e. a unit circle stretched on the x- and y-axis) when viewed in the direction of flow; in particular, apart from the at least one deformation, the cross-section corresponds to a unit circle, in particular, the inner wall may represent an oval and in so doing deviate from the unit circle by a maximum of 20%, preferably a maximum of 10%, in particular a maximum of 5% and in particular a maximum of 2% (therefore being ‘elongated in the direction’ of an oval). This deviation relates in this case to the basic shape, not to the deviations from the unit circle caused by the at least one deformation.

In the context of the present invention, the concentrator can be integrally formed with the cavity, or it can be placed on the cavity; in the latter case, care should be taken to ensure that the lower opening of the concentrator is adapted to the opening of the cavity, because this enables an optimal transfer of light from the concentrator to the cavity (so that the entire size of the cavity's entrance is used and some of the light is not blocked by the outer wall of the cavity).

The photoreactor according to the invention, and thus also the concentrator and cavity, are preferably elongated and straight, and thus, in other words, have a depth, seen in the flow direction, whose amount is greater, in particular significantly greater, than the height of the photoreactor (i.e. than the sum of the heights of the cavity and concentrator).

For example, the photoreactors according to the invention may have the following dimensions: a specific example of a single-channel reactor that has been successfully tested had the following characteristics: d1=5 mm; d2=2.3 mm; d3=7.8 mm; d4=11 mm. This example accordingly represents a particularly preferred embodiment of the present invention for use as a single photoreactor.

Another example of a channel array, i.e. for the interconnection of several photoreactors according to the invention, had the following key data: d1=9 mm; d2=3.3 mm; d3=8 mm; d4=14.3 mm. This example thus represents a particularly preferred embodiment of the present invention for use in photoreactor arrays.

The latter example is particularly well suited, but by no means limited, for example for the photocatalytic reduction of 2 mM potassium trioxalatoferrate solution. The depth in the direction of flow (i.e. the length of the distance that the medium flows along the reactor) varies greatly depending on the respective application (for example, depending on the chemical reaction, the desired conversion, etc.). As a rule, it is significantly greater than the ‘height’ of the channel cross-section, in this example (much) greater than 100 mm.

As is known to the person of ordinary skill in the art, the exact dimensions of the photoreactors according to the invention can be adapted while observing the above conditions (1), (2) and (3). The person of ordinary skill in the art can therefore easily adapt this based on their general knowledge in the art, if necessary with the help of simple preliminary tests.

The photoreactors according to the invention are preferably used to capture and utilise sunlight. However, it is also possible to use the photoreactors according to the invention with other light, for example UV light or infrared light, preferably UV light, or a combination of UV light, visible light and/or infrared light in proportions other than those of sunlight. For this purpose, the surfaces or the reflecting layers of the concentrator and/or cavity can optionally be adapted to the wavelengths of the incident light, for example by changing the coating or coating composition of the reflecting layer. This makes it possible to use the photoreactors according to the invention for a wide range of applications.

In preferred embodiments of the present invention, the deformations are respectively dents or bulges with respect to the ellipsoidal, preferably circular, cross-section of the cavity with deformation depths in the range of between 1% and 20% of the diameter of the cavity (d3), wherein the deformations are preferably dent-shaped, that is to say smooth dents and bulges or protrusions or recesses.

In further preferred embodiments, dents or bulges are also formed at other locations on the cavity surface in order to continuously reflect the light in the cavity. Preferably, a whole series of deformations are designed so that the light is reflected within the cavity as often as possible and consequently passes through the reaction volume as often as possible; particularly preferably, the beams cross as often as possible where a photocatalyst (if used) is arranged or where a reaction is taking place (or should take place).

The photoreactors according to the invention are not limited to use for light-induced or light-supported reactions; they can also be used as a kind of heat collector and use the captured (sun) light to heat liquids, preferably water, flowing through the cavity.

In preferred embodiments of the present invention, the insides of the concentrator or the cavity or the concentrator and the cavity are highly reflective for the incoming light, that is, they have a high degree of reflection of >80%, preferably >90%, for the incoming light.

This can be achieved, for example, by mirroring or polishing the surfaces.

‘Mirrored’ can be inherent in the material, for example in some metals, or can be achieved by applying material to the concentrator or cavity surface. Possibilities for such an application are dip coating, vaporisation, PVD, CVD (physical or chemical vapour deposition). Processing the surfaces of the structure, in particular by polishing, can also lead to a reflective surface.

The surfaces may, if they are made of metal, be reworked, for example, by micro-milling, manual polishing and/or galvanic silver coating to increase reflectivity. Furthermore, components that are manufactured using wire EDM, polymer extrusion, etc., can also be reworked using other processes. If PMMA (polymethyl methacrylate) is used as the material, flame polishing is one option, for example, and suspension polishing, for example, for wire-eroded components, etc.

Care must be taken to ensure that the optical coatings used for the present invention (e.g. silver or aluminium) have the reflectivities mentioned in the relevant UV-VIS band. Values of degree of reflection of less than 80% lead to poorer results, since the proportion of absorbed light would become too great due to the multiple reflections.

If the material of the concentrator and/or cavity is optically permeable (e.g. PMMA), either the inside or the outside can be coated. The latter is often easier for purely practical reasons and is therefore preferred in some embodiments. If the materials are opaque, the reflective layer is naturally applied to the inside.

The reflective coating can consist of or be based on aluminium or silver in variants of the present invention.

The coating can also contain materials that cause a wavelength shift of the incident light, if desired.

Thus, in a preferred embodiment of the present invention, the concentrator and cavity are made of a transparent polymer, preferably polymethyl methacrylate, and the outer sides of the concentrator or cavity or concentrator and cavity are highly reflective for the incident light, in particular have a degree of reflection of at least 80%, and are preferably polished or mirrored.

In preferred embodiments of the present invention, one or several photocatalysts are arranged in the cavity, preferably on a light-permeable and/or (translucent) only weakly light-absorbing carrier. In this context, ‘light-permeable’ means that the absorption coefficient of the carrier must be significantly smaller than that of the photocatalyst used, so that the proportion of light absorbed by the catalyst is large compared to the proportion absorbed by the carrier. The quantification of this property depends on the respective system, i.e. radiation belt, reflectivity in the cavity, type of catalyst and type of reaction medium, and therefore cannot be defined in general terms. However, the person of ordinary skill in the art can readily adapt this on the basis of his general expertise, if necessary with the help of simple preliminary tests. It is particularly preferred in some embodiments of the present invention when a light-permeable vessel, preferably a tube, in particular made of glass or plastic transparent to the incoming light, is arranged in the cavity; in these embodiments, one or several photocatalysts can then be arranged, in particular also on a corresponding carrier.

In principle, these carriers can be any structure and/or material, as long as they allow sufficient incoming light to pass through to the photocatalyst or shadow as little as possible. Therefore, materials that are transparent to the incoming light are preferred.

In the context of the present invention, ‘weakly light-absorbing’ in the context of the carrier means a proportion of the light absorbed by the carrier in the light coupled into the system of less than 20%, preferably less than 10%, particularly preferably less than 5% (in a single beam passage, not cumulative over several beam passages). Suitable materials for the carriers are, in particular, plastics (such as PMMA) or glass. These carriers may, for example, be in the form of gratings. Aerogels are also suitable.

In some further embodiments of the present invention, cooling or heating structures, in particular cooling fins or heat transfer channels, are arranged around the cavity on the outside.

In some preferred embodiments of the present invention, the photoreactor is surrounded on the outside by supporting structures which may optionally comprise devices for connecting to further photoreactors, preferably click connections, slide-in connections, screw connections or clamp connections. The cooling or heating structures mentioned can be incorporated into or integrated into these supporting structures.

In further preferred embodiments of the present invention, the photoreactors have, as viewed in the flow direction, connections at one or both ends of the respective cavities, via which liquid, for example reaction medium, can be supplied and discharged.

Several photoreactors can also be connected ‘in series’ via corresponding connections, resulting in a flow channel.

In some preferred variants of the present invention, the photoreactors are configured as single reactors and have no connections. In this case, filling the reactors with reaction medium is done via the concentrator. This configuration is particularly suitable for laboratory experiments, mechanistic investigations and the like.

Furthermore, a subject matter of the present invention is a photoreaction array comprising a plurality of photoreactors according to the invention, optionally enclosed by a housing that is open at the top (i.e. the side where light enters) (and closed at the bottom and on several, preferably, all sides) or by an enclosure that is open at the bottom and top (i.e. the side where light enters).

These arrays are particularly suitable when there is a lot of light and a large area, for example building roofs and sunlight.

When the arrays according to the invention are used on roofs, in preferred embodiments of the present invention the photoreactors in the arrays are aligned along an east-west axis, in particular in such a way that the projection of the reaction channels in a horizontal plane is parallel to an east-west axis. This can be realised on the roofs of houses that are not aligned along an east-west axis by arranging the arrays at an angle on the roof. Furthermore, in some embodiments of the present invention, the aperture normal is preferably aligned with the solar path at the equinoxes, resulting in a latitude-dependent inclination of the arrays.

Another particular subject-matter of the present invention is a method for producing photoreactors, preferably the photoreactors according to the invention, comprising the steps of
a) producing the concentrator and cavity by additive manufacturing processes, in particular 3D printing or extrusion;
b) if the surfaces of the concentrator and/or cavity do not already have a sufficiently high degree of reflection for the incident light due to the production in step a), treating the inner or outer surfaces of the concentrator and cavity by polishing or mirroring, in particular as described above by means of solution deposition, CVD, PVD,
c) optionally inserting a reaction vessel, in particular a tube, preferably made of glass or plastic (as described above), into the cavity.

In preferred variants of this subject-matter of the present invention, the geometry of the cavity is determined beforehand (and in conjunction with a (suitable) concentrator), preferably with the aid of an algorithm, in particular based on MATLAB®, by the following steps:
i) providing a cavity with a predetermined geometry, preferably an ellipsoidal or, in particular, circular cross-section,
ii) specifying deformation parameters that describe at least one deformation with regard to the location on the wall of the cavity, the width and depth of the at least one deformation,
iii) deforming the cavity geometry on the basis of the deformation parameters, in particular at the point of incidence of the primary light beam,
iv) determining the reflection values, in particular the frequency of reflections, of the primary light beam within the cavity, reflection values, and optionally storing the determined values, or determining the functionality of the modified geometry with regard to the photocatalytic efficiency achieved, and optionally storing the determined values,
v-a) repeating steps ii) to iv) several times, wherein in step ii) respectively modified deformation parameters are specified, and comparing the respectively determined reflection values or photocatalytic efficiency with the previously determined reflection values or photocatalytic efficiency values,
v-b) terminating the repetition of steps ii) to iv) as soon as the reflection values or the photocatalytic efficiency in a cavity geometry with one or several deformations has reached a desired quality, preferably when the optimal, in particular highest, frequency of reflections of the primary light beam within the cavity has been achieved,
vi) outputting the determined cavity geometry.

The modified deformation parameters may thereby represent other, alternative deformations and/or superpositions of the first at least one deformation with further deformations.

In preferred embodiments, in the first iteration of step ii), the location of the at least one deformation is randomly specified.

In further preferred embodiments, the location of at least one deformation is selected to be the same as, or include, the location of the primary light beam impingement during the first iteration of step ii).

In some preferred embodiments of this subject matter of the present invention, repeating steps ii) through iv) is terminated as soon as one deformation or a number of deformations results in an improvement of the reflection values (increase in reflection frequency) or an increase in photocatalytic efficiency.

In other preferred embodiments of this subject matter of the present invention, the modified deformation parameters for step ii) are obtained by optimising deformation parameters that have led, in an optimisation process, for example a ‘pattern search’ process, to an improvement in the reflection values (increase in reflection frequency) or an increase in the photocatalytic efficiency. Preferably, these parameters are then stored. In the next iteration (repeating steps ii) to iv)), these improved deformation parameters are then used as a basis for comparison, an improvement in the reflection values (increase in the reflection frequency) or an increase in the photocatalytic efficiency is then assessed in relation to these already improved parameters and not in relation to the original parameters. This can be repeated until no further improvement can be achieved.

The improved deformation parameters can be completely new deformations, which are set instead of the first deformation, whereby the at least one deformation from the first iteration of the process is thus replaced.

In other, often preferred, variants, the deformation parameters, i.e. the deformation or deformations from the first iteration, are set and further additional deformations are added in each of the next iterations; the resulting geometry is usually (but not necessarily—it may also be that the first deformation parameters provide the best results) a geometry with numerous (also superimposed) deformations.

Another special subject-matter of the present invention is a method for optimising the cavity geometry of a photoreactor, preferably a photoreactor according to the invention, preferably with the aid of an algorithm, in particular based on MATLAB®, comprising the steps of
i) providing a cavity with a predetermined geometry, preferably ellipsoidal or, in particular, circular in cross-section,
ii) specifying deformation parameters that describe at least one deformation with regard to the location on the wall of the cavity, the width and depth of the at least one deformation,
iii) deforming the cavity geometry on the basis of the deformation parameters, in particular at the point of incidence of the primary light beam,
iv) determining the reflection values, in particular the frequency of reflections, of the primary light beam within the cavity, reflection values, and optionally storing the determined values, or determining the functionality of the modified geometry with regard to the photocatalytic efficiency achieved, and optionally storing the determined values,
v-a) repeating steps ii) to iv) several times, wherein in step ii) respectively modified deformation parameters are specified, and comparing the respectively determined reflection values or photocatalytic efficiency with the previously determined reflection values or photocatalytic efficiency values,
v-b) terminating the repetition of steps ii) to iv) as soon as the reflection values or the photocatalytic efficiency in a cavity geometry with one or several deformations has reached a desired quality, preferably when the optimal, in particular highest, frequency of reflections of the primary light beam within the cavity has been achieved,
vi) outputting the determined cavity geometry.

In preferred embodiments, during the first iteration of step ii), the location of the at least one deformation is randomly prescribed.

In further preferred embodiments, during the first iteration of step ii), the location of at least one deformation is selected to correspond to, or include, the location of incidence of the primary light beam.

In some preferred embodiments of this subject matter of the present invention, repeating steps ii) through iv) is terminated as soon as one deformation or a number of deformations results in an improvement of reflection values (increase in reflection frequency) or an increase in photocatalytic efficiency.

In other preferred embodiments of this subject matter of the present invention, the modified deformation parameters for step ii) are obtained by optimising deformation parameters that have led to an improvement in the reflection values (increase in reflection frequency) or an increase in the photocatalytic efficiency, in an optimisation process, for example a ‘pattern search’ process. Preferably, these parameters are then stored. In a next iteration (repeating steps ii) to iv)), these improved deformation parameters are then used as a basis for comparison, an improvement in the reflection values (increase in the reflection frequency) or an increase in the photocatalytic efficiency is then assessed in relation to these already improved parameters and not in relation to the original parameters. This can be repeated until no further improvement can be achieved.

The improved deformation parameters can be completely new deformations, which are set instead of the first deformation, whereby the at least one deformation from the first iteration of the process is thus replaced.

In other, often preferred, variants, the deformation parameters, i.e. the deformation or deformations from the first iteration, are set and further additional deformations are added in each of the next iterations; the resulting geometry is usually (but not necessarily—it is also possible that the first deformation parameters provide the best results) a geometry with numerous (also superimposed) deformations.

Finally, a particular subject matter of the present invention is the use of the photoreactors and/or photoreaction arrays according to the invention for photocatalytic reactions, preferably photosynthesis processes, for use on surfaces from 5 cm² to several hectares, preferably open terrain surfaces or external building surfaces, in particular on roofs, or for heating and/or sterilising liquids flowing through the cavity, preferably water, or for the (catalytic) conversion of CO₂ and H₂O to chemical energy carriers.

In the context of the present invention, the concentrator is preferably symmetrical, i.e. both sides or both walls are the same height.

In other preferred embodiments of the present invention, the concentrator is designed to be non-symmetrical. This variant can be used in particular in lighting situations in which it is not possible to align the aperture normal to the sun's path at equinox.

In further embodiments of the present invention, the coatings of the walls of the concentrator and/or cavity can be designed in such a way that they cause a shift in the wavelengths of the incident light. In some variants, this can be useful and preferred in order to adapt the incident light, which is preferably sunlight, to the absorption properties of the respective photocatalyst (or catalyst system) and/or the reactant(s) arranged in the reaction chamber (in the cavity).

In further embodiments of the present invention, a thermally activatable catalyst (or catalyst system), which is heated and activated by the light beams incident and reflected in the cavity, can be used instead of a photocatalyst.

The entrance of the cavity through which the light collected by the concentrator enters the cavity may be a simple window or, when reaction tubes are used in the cavity, a simple hole. These are the usual cases and are therefore preferred embodiments of the present invention.

In other preferred embodiments of the present invention, an optical lens or lens group may be arranged in this entrance, whereby it is possible to precisely control the incoming light, for example to focus it on a desired location or to distribute the incoming beams.

In still other preferred embodiments of the present invention, an optical element can be arranged in this entrance, which selectively reflects or transmits light of certain wavelengths, which in particular in the case of wavelength shifts in the cavity (for example, by means of corresponding coatings of the cavity's inner walls or (reaction) media, carriers and/or catalysts arranged in the cavity) lets the incident light in the corresponding wavelengths through, but no light of corresponding other wavelengths is allowed to escape, whereby loss due to re-emerging light beams can be prevented or reduced.

The following can also be stated about the present invention:

The panel-like, micro-structured and cost-effectively produceable photoreactor design according to the invention is characterised by a clever optical design which, among other things, ensures high photocatalytic efficiency in photosynthesis throughout the entire year without the need for mechanical alignment of the reactor panels to the current position of the sun. In particular, with a preferred east-west orientation and an inclination of the photoreactors according to the invention adapted to the latitude.

Expensive and maintenance-intensive solar tracking, as is usually necessary in CSP (concentrated solar power) power plants or in the area of solar fuels, is no longer necessary. The operating costs are significantly reduced due to the elimination of the solar tracking. The geometry of the microstructuring allows for cost-effective production, e.g. via additive manufacturing processes such as 3D printing or extrusion of polymers (for example with subsequent aluminium deposition). The photoreactor design according to the invention can also minimise the amount of expensive photocatalysts used by means of a high catalyst utilisation. The homogeneous illumination of the reaction zone ensured by the specific design guarantees that a photocatalyst used can be operated at its optimum operating point.

The core element of the photoreactor design is a microstructured reaction channel that guides incident light from different directions into a mirrored cavity. The microstructuring is achieved or represented by the deformations described above. Many photoreactors arranged in parallel (array) make it possible to cover large areas (of any size). In some embodiments of the present invention, a photocatalyst, which absorbs the introduced light and uses it for the conversion of, for example, CO₂ and water to an energy carrier, is present in the cavity, supported on a transparent, preferably also porous, structure. Light that is not absorbed or scattered by the catalyst during the first passage of the reaction zone is preferentially guided back to the catalyst by the mirrored walls of the cavity.

The geometry of the cavity is optimised in preferred embodiments of the present invention with regard to the ability to guide incident, transmitted and scattered light into the reaction zone.

The latter property of the cavity ensures a high radiation transport efficiency despite the optical dilution of the catalyst. The optical dilution of the catalyst and the good optical connection that this ensures guarantees optimal operating conditions for all of the photocatalyst in the system. In this context, ‘optimal’ means that the catalyst is operated at high catalyst utilisation and at the same time without any loss in the quantum yield achieved. Both properties together-a high radiation transfer efficiency and optimal operating conditions-guarantee a high photocatalytic efficiency of the overall system.

In one embodiment of the present invention, the production of the arrays of photoreactors can be carried out by inexpensive extrusion of plastics with a subsequent optical coating, for example by physical vapour deposition (PVD) of aluminium or silver.

The photocatalyst can be incorporated into these polymer-based and optically coated moulded extrudates, for example, by gelling catalyst-loaded silica alcogels with subsequent supercritical drying and the associated formation of a translucent aerogel.

In some embodiments of the present invention, the photocatalytically active panels (i.e. the photoreactor arrays according to the invention or a plurality of photoreactors according to the invention) are integrated into a housing and statically aligned at the point of use to optimally suit the local lighting conditions. In this context, optimal alignment means that the photocatalytic efficiency achieved as an annual average is maximised by suitable inclination and orientation of the panels. For different orientations of the roof surface (compass direction and inclination) as well as different locations (latitude), the best possible radiation transfer efficiencies can be achieved by optimising the geometry of the mirrored walls of the photoreactors. In this way, an economically viable number of different geometries can be produced in variants of the present invention, each of which is optimised for a range of roof orientations and inclinations, as well as latitude. The modular design in the context of the present invention allows for an uncomplicated expansion of existing systems and an easy replacement of panels whose photocatalytic efficiency has decreased over time due to possible aging of the catalyst or the optical coating.

The photoreactor panels (arrays) according to the invention are characterised by a clever optical design that ensures a high photocatalytic efficiency and a good catalyst utilisation in a wide range of angles of incidence. Furthermore, the materials that can be used for production also enable cost-effective production.

A novel aspect of the present invention is the geometry of the reaction channel, which only slightly concentrates light (concentration factor C=2-3, in particular 2.5) and guides it into the actual reaction zone in the mirrored cavity. The suitably chosen dimensions of the reaction zone or an appropriately selected optical layer thickness—the latter for the case that the walls of the cavity and/or concentrator are optically transparent for the incident light and have a reflective coating on the outside—also ensure that a number of two to ten beam passages already lead to significant absorption in the reaction volume, while the entire reaction volume is still illuminated. Due to the low concentration ratio of the concentrating optics and the channel-like geometry efficient operation even without solar tracking is ensured.

Since photocatalytic systems generally allow very low penetration depths for light (in the range of a few micrometres to hundreds of micrometres), despite optical dilution, the suitably chosen dimensions mentioned above are in the range of a few hundred micrometres to a maximum of a few centimetres. Accordingly, it is basically not possible to effectively illuminate larger bulk volumes directly, and a milli- to micro-structuring of the reaction zone is ultimately unavoidable.

The new photoreactor design combines the advantages of photoreaction technology with complex tracking optics that efficiently guide incoming light at all angles of incidence to the photocatalyst, with the simple design of a plain photoreactor panel (array) that is easily expandable, inexpensive to produce and uncomplicated to operate and maintain. The microstructuring ensures homogeneous illumination of the reaction zone, high utilisation of the catalyst and ideal operating conditions for the entire catalyst volume.

The photoreactor design according to the invention thus essentially consists of a concentrator and an optical cavity. The reaction volume is located in the cavity. The two main components—concentrator and cavity—have the following functionality:
The concentrator ‘captures’ light in the relevant angle of incidence range and guides it into the cavity.
The cavity ensures multiple passages of coupled beams through the reaction volume by the deformation of the circular base geometry.

In particular embodiments of the present invention, the photoreactors according to the present invention have the following five properties (in particular with which they enable efficient, cost-effective, sunlight-supported photosynthesis):
1. They ensure that as much of the incident light as possible is absorbed in the reaction zone (=they have a high radiation transport efficiency in the relevant wavelength range—η_{T,λ}—).
2. They ensure that the ideal conditions for the synthesis exist throughout the reaction volume. This applies in particular to the local volumetric photon absorption rate

$$- {L}_{p , λ}^{a} - ,$$

which is a measure of how much light is absorbed per unit of time and volume at a given location in the reaction volume (=local process intensity).
3. Criterion 1. is valid over the entire range of angles of incidence, which results from the sun's daily and annual cycle.
4. Criterion 3. is fulfilled without tracking the sun.
5. The geometry of the reactor can be produced with inexpensive materials and with known mass production methods.

(Additional information: From the daily course of the sun in the sky, a required acceptance angle of +90° in the plane of the solar orbit and from the annual cycle, an acceptance angle of +23.5° in a plane perpendicular to the plane of the ecliptic results.)
(a) Criterion 2 can only be fulfilled if the reaction volume can be ‘shone through’ from the outside, i.e. if it is not optically dense. The illumination will be more homogeneous if only a small portion of the energy (=photons) of the beam is absorbed during a beam passage. This has the consequence that a large proportion of the light directed onto the reaction volume ‘shines through’ it and is not absorbed. This in turn means that the proportion of the light directed onto the reaction volume that is absorbed in the reaction volume is small (=η_{T,λ} is small).

Furthermore, criterion 1, and (a), and thus also criterion 1, and criterion 2., are only compatible if light that ‘shines through’ the reaction volume is redirected and passed through the reaction volume again without being absorbed.

Taking criterion 4 into account as well, this results in a photoreactor design that can ensure multiple passages of incident light through the reaction volume at a variable angle of incidence.

So to ensure that criteria 1 to 5 are met, the following is important in the context of the present invention:
That the ratio of the aperture width of the concentrator (d1) to the width of the entrance to the cavity (d2) is in a range of 2 to 3.
That the ratio of the length of the concentrator (d4) to the aperture width of the concentrator is in a range of 0.5 to 2.5.

That the aperture width (d1) is greater than the diameter of the cavity (d3).

In some special embodiments of the present invention, the characteristic diameter of the cavity d3 can be determined in dependence of the reaction volume as follows:
i) The characteristic diameter of the cavity is set such that the reaction volume with a given absorption coefficient can be shone through.
ii) The characteristic diameter of the cavity at the same time is set such that a ‘reasonable’ number of passages of the light beam ensures absorption of the majority (>90%) of the coupled-in radiation.
Furthermore, the absorption coefficient of the reaction volume is set such that a significant proportion of the light that is absorbed in the cavity is absorbed in the reaction volume (and not in a possibly transparent but still somewhat absorbing wall or optical coating).
iii) In other words, the absorption coefficient of the reaction volume is set (by suitable optical dilution of the photocatalytic system used) such that, despite the occurrence of parasitic absorption (if given) in the wall of the cavity and the optical coating of the cavity, nr, is at least 60% (=fulfilment of criterion (1)).

These considerations i) to iii) represent a coupled system. In all three considerations, optical transport properties of the reaction volume and the reactor components and characteristic dimensions of the same play a role. This challenge can be addressed as follows:

The (dimensionless) absorbance of the reaction volume (A_{RV}) is sought, defined according to equation (1), such that the (dimensionless) radiation transport efficiency η_{T,λ} has a maximum value, but at least 60%, AND the (dimensionless) number of passages of a beam (Nₘᵢₙ) necessary to absorb at least 90% of the coupled-in light, lies in a range of 2 to 10. The boundary conditions given are the (dimensionless) reflectivity of the optical coating (R) and the (dimensionless) absorbance of the cavity's wall (A_{W}), defined according to equation (2).

A_{RV}=σ_{RV}d3 (1)

A_{W}=σ_{W}d5 (2)
The sought-after absorbance of the reaction volume can be estimated using equation (3). The required number of passages follows from equations (4) and (5).

$${A}_{R V} = - ln [ \frac{R exp ( - {A}_{W} ) - {η}_{T , λ}}{R exp ( - {A}_{W} ) ( 1 - {η}_{T , λ} exp ( - {A}_{W} ) )} ] \qquad ( 3 )$$

$${N}_{min} = \frac{ln ( 0.1 )}{ln ( {f}_{1} )} \qquad ( 4 )$$

$${f}_{1} = R exp ( - 2 {A}_{W} ) exp ( - {A}_{R V} ) \qquad ( 5 )$$

In order to fulfil considerations i) to iii), the absorbance of the reaction volume typically lies in a range of 0.2 to 1.1. Accordingly, if the walls of the cavity consist of a material that is transparent to the incident light and are treated to be reflective on the outside, then, in preferred variants of the present invention, the diameter of the cavity (d3) and the absorption coefficient of the reaction volume (ORV) are defined in dependence of the reflectivity of the optical coating of the cavity (R) and the absorption coefficient (ow) of the wall of the cavity and its wall thickness (d5), such that a number of 2 to 10 passages of a coupled-in beam leads to an absorption of the beam energy of at least 90% and the radiation transport efficiency η_{T,λ} achieved thereby achieves a maximum, but is at least 60%. This is the case for relevant material systems and wall thicknesses of the cavity's wall (R>90% and A_{W}<<0.2) at an absorbance of the reaction volume (σ_{RV}d3) in the value range from 0.2 to 1.1.

Ideal beam paths (in the cavities of the photoreactors according to the invention) are characterised by two properties:
The ratio between the beam segment length in the reaction volume and in the cavity's wall is maximal. This minimises losses due to parasitic absorption in the cavity's wall.
The length of the beam segment in the reaction volume is maximised. This minimises the number of necessary passages and thus the losses due to parasitic absorption by the optical coating.

In a circle-like geometry, i.e. a circular geometry with corresponding deformations, ideal beam paths go through the centre of the geometry.

Accordingly, in some embodiments, it is preferred in the context of the present invention that the optical elements at the entrance to the cavity or on the wall of the cavity are designed such that coupled-in beams are guided as often as necessary (about 2 to 10 times, see above) preferable through the centre of the reaction volume. A derivation of suitable geometries is possible by means of a (free-)form optimisation tailored to the respective material system, for example as shown above by means of algorithms, preferably based on MATLAB®, C++, Python, in particular MATLAB®.

In the present invention, in particular, deformations of the kind are provided that the majority of incident beams are guided through the reaction volume in as many passages as possible, so that, on the one hand, a high proportion of the incident radiation energy is absorbed in the reaction volume and, on the other hand, the entire reaction volume is illuminated as homogeneously as possible. Accordingly, an incident beam, in particular the primary incident light beam, is not immediately reflected out of the cavity again. This leads to high radiation transport efficiency and homogeneous illumination of the reaction volume. Taken together, both ensure a high photocatalytic efficiency in a photosynthesis.

In the context of the present invention, it is possible to achieve a high photocatalytic efficiency with simultaneously low system costs in that due to the geometry and the specific design of the photoreactors:
1) no tracking of the position of the sun is required;
2) optimal operating conditions for a catalyst are ensured;
3) the catalyst utilisation (efficiency), if used, is high;
4) a high radiation transport efficiency is ensured.
In addition, the costs are low in the context of the present invention, in that:
5) it can be manufactured from polymers using low-cost processes, preferably additive manufacturing methods, in particular 3D printing and/or extrusion.
Furthermore, the present invention is advantageous because the system
6) is modularly expandable and easy to maintain.

The individual parts of the devices according to the invention are operatively connected to each other in a manner customary and known in the art.

The various embodiments of the present invention, e.g.—but not limited to—those of the various dependent claims or individual embodiments described in the figures, may be combined with each other in any manner, provided that such combinations do not contradict each other.

The embodiments of the present invention, which are explained in more detail below with reference to the figures, represent various preferred embodiments. Many of the features or embodiments shown below in individual figures can be combined with features and embodiments shown in other figures or in the remaining description, in particular where the features are described accordingly. Furthermore, the figures are not to be interpreted in a limiting way and are not to scale. In addition, the figures do not contain all the features that the usual devices/systems have, but are reduced to the features that are essential for the present invention and for understanding it; for example, screws, hoses, etc. are not shown or are not shown in detail.

The same reference signs/numbers mean the same or equivalent device parts.

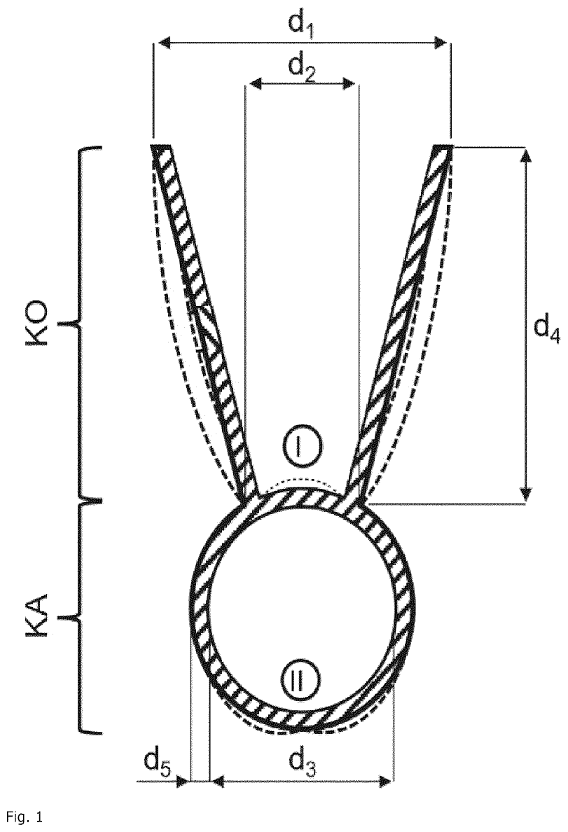

FIG. 1 shows a schematic cross-section representation of a photoreactor 1 according to the invention. The concentrator KO and the (optical) cavity KA are indicated by curly brackets, respectively. Furthermore, in the figure the characteristic parameters of the aperture width d1, the width of the entrance to the cavity d2, the characteristic diameter of the cavity d3 (=largest inner diameter) and the length of the concentrator d4, as well as the wall thickness of the cavity wall d5 are shown. Furthermore, different areas are shown, on the one hand as I the entrance to the cavity and as II the area of the cavity in which light beams hit the (mirrored) inner wall of the cavity in the centre of the cavity after a first beam passage through the cavity (the reaction volume). The dashed lines in FIG. 1 indicate how the walls can be designed in variants of the present invention. On the one hand, it is indicated that the legs of the concentrator can be curved (in deviation from the ideal V-shape or as a cross-section of a CPC). On the other hand, various deformations wall are indicated for the cavity, by means of which the reflection directions of incoming beams can be influenced.

It should be explicitly noted that this figure is intended to show which elements of the photoreactors according to the invention are arranged where and how; the conditions (1), (2) and (3) required according to the invention and the dimensions of the wall variations are not intended to be correctly represented by the schematic FIG. 1.

In FIG. 1, the walls of concentrator KO and cavity KA are shown as hatched, outlined surfaces. This illustrates that, in this example, they are made of a material that is optically transparent to the incoming light. In this example, the outer surfaces of concentrator KO and cavity KA are also coated with a reflective layer, which is represented by a thicker line. It can be seen from this figure that the characteristics d1, d2 and d4 act on the respective ‘ends’ of the coatings and not on the inner walls (they would act on the inner walls if these were coated or if the walls were made of reflective metal), the characteristic d3, however, on the inner walls of the cavity.

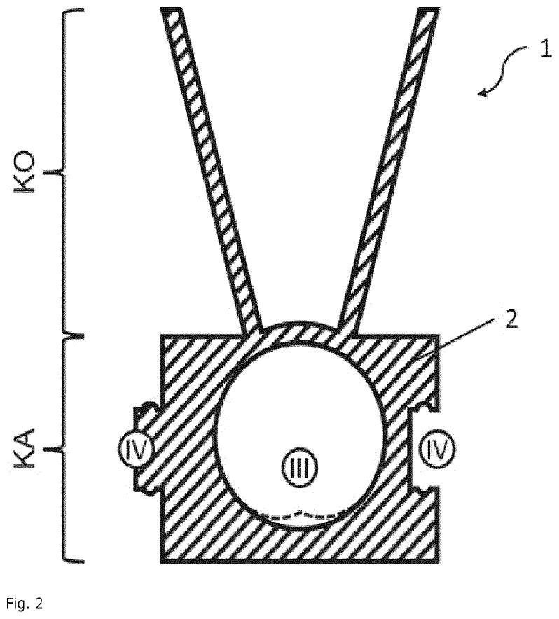

FIG. 2 illustrates, also not to scale, a possible embodiment of a photoreactor according to the invention. It should be explicitly noted that FIG. 2 is also not intended to correctly represent the conditions (1), (2) and (3) required by the invention. In FIG. 2, the photoreactor 1 according to the invention is surrounded by a supporting structure 2. This may contain cooling or heating structures (not shown). III denotes an area with schematised deformations for deflecting the reflection of incident light. Shown here on the two sides are optional connecting devices (or connecting areas) IV, by means of which several photoreactors can be connected to one another, for example to form photoreactor arrays according to the invention.

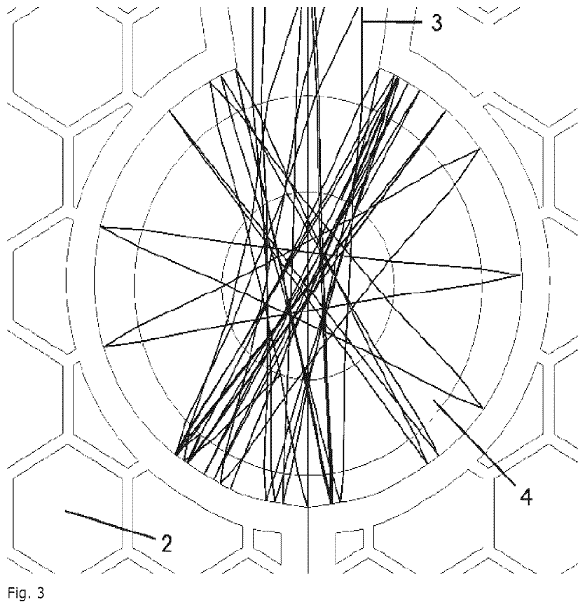

FIG. 3 illustratively shows, for a photoreactor 1 according to the invention, which is surrounded by a supporting structure 2, a beam path of an incident primary light beam 3, which is redirected by a deformation on a wall of the cavity. In addition, a tube 4 (for example made of glass or plastic) is shown in this figure, which contains a photocatalyst in its centre and through which the reaction medium is passed. It can be clearly seen how the light beam 3 is deflected multiple times and as such a much better utilisation of the light beam is given than if it were reflected directly out of the cavity.

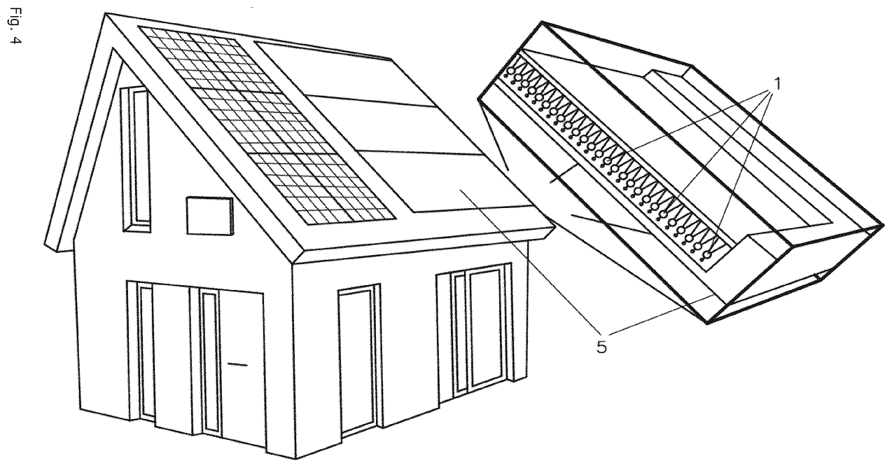

FIG. 4 shows a schematic representation (of a use) of a photoreaction array 5 according to the invention comprising a plurality of photoreactors 1 according to the invention on a house roof. The section shows the milli-/microstructure of a panel-type photoreaction technology within the scope of the present invention, in which hundreds of photoreactors 1 arranged in parallel each enclose small reaction volumes.

### LIST OF REFERENCE SIGNS

1 photoreactor
2 supporting structure (e.g. for 3D-printed photoreactor)
3 primary light beam
4 tube (e.g. made of glass or plastic)
5 photoreactor array
KO concentrator
KA (optical) cavity
d1 aperture width
d2 width of the entrance to the cavity
d3 characteristic diameter of the cavity (=inner diameter)
d4 length of the concentrator
d5 wall thickness of the transparent material
I entrance area into the cavity
II area in which the primary light beam strikes the mirrored inner wall of the cavity
III area with schematised deformations to redirect the reflection of incident light
IV connecting device (connection area)

The invention will now be explained with reference to the following non-limiting examples.

### EXAMPLE 1

The photoreactor design was demonstrated in a laboratory reactor for a model photocatalytic reaction. The geometric dimensions were scaled to allow for better handling. The reactor characteristics were: d1=5 mm; d2=2.3 mm; d3=7.8 mm; d4=11 mm.

The photoreactor was modelled in view of beams in a MATLAB®-based simulation environment and optimised in terms of geometry using optimisation algorithms developed specifically for this application. The aim of the optimisation was a photocatalytic efficiency as high as possible at perpendicular incidence of light in the concentrator. The optimised geometry was produced in stainless steel using 3D printing. The optical surfaces were then reworked by micro-milling, manual polishing and galvanic silver plating to ensure high reflectivity in the relevant wavelength range.

The optics produced in this way were employed in a sun-supported photocatalytic example reaction (photocatalytic reduction of iron-(III)-oxalate to iron-(II)-oxalate). A comparison between simulated and experimentally determined photocatalytic efficiencies showed good agreement between simulation and reality. Furthermore, the variation of the angle of incidence of the light carried out in the experiment and in the simulation showed that in an angle of incidence range of plus/minus 20° to the perpendicular, the tested geometry (according to the invention) reliably coupled light into the reaction zone. An alignment with the sun, accordingly, was not necessary.

### EXAMPLE 2

Another example was carried out, wherein this time the reactors were arranged as a channel array. The reactors had the following characteristics: d1=9 mm; d2=3.3 mm; d3=8 mm; d4=14.3 mm.

In this example, the photocatalytic reduction of 2 mM potassium trioxalatoferrate solution was investigated. Here, too, the photoreactors according to the invention showed a very high degree of effectiveness, thus demonstrating that they also achieve very good results as flow-through reactors.

In could be shown with the aid of the examples that the reactors and methods according to the invention achieve favourable effects and that the objects underlying the present invention could be solved.

1. A photoreactor, in particular for sun-supported photosynthesis, comprising a concentrator and a cavity configured as a flow-through reactor,
wherein the concentrator, viewed in the flow direction, has a V-shaped cross-section open at the bottom or is configured as a compound parabolic concentrator, which is in direct contact at its lower end with the cavity and forms an entrance area to the cavity there,
has an aperture width d1,
has a width of the entrance to the cavity d2 and
a height d4;
the cavity inner wall, viewed in the direction of flow, has an ellipsoidal cross-section with a diameter d3, which, in the area of incidence of the primary incident light beam, has at least one deformation of such a kind that the light beam reflected from the point of incidence is not reflected directly out of the cavity again;
and wherein
(1) the ratio of d1 to d2 is in a range of 2 to 3,
(2) the ratio of d4 to d1 is in a range of 0.5 to 2.5.

2. Photoreactor according to claim 1, wherein:
(3)a for a configuration as a single photoreactor, d1 is smaller than d3 or equal to d3, or
(3)b for a configuration as one of several interconnected photoreactors, d1 is greater than d3.

3. The photoreactor according to claim 1, wherein:
the deformations are in the form of dents or bulges with respect to the ellipsoidal, preferably circular, cross-section of the cavity, and
the depths of deformation are in the range of between 1% and 20% of the diameter of the cavity d3 and wherein the deformations are preferably dent-shaped.

4. The photoreactor according to claim 1, wherein the insides of concentrator or cavity or concentrator and cavity are highly reflective for the incident light, that is have a degree of reflection of at least 80%, preferably are polished or mirrored.

5. The photoreactor according to claim 1, wherein:
the concentrator and cavity are made of a transparent polymer, preferably polymethyl methacrylate, and
the outer sides of the concentrator or cavity or concentrator and cavity are highly reflective for the incident light, in particular have a degree of reflection of at least 80%, and are preferably polished or mirrored.

6. The photoreactor according to claim 1, wherein one or several photocatalysts are arranged in the cavity, preferably on a light-permeable carrier, more preferably in a light-permeable vessel, in particular a tube, arranged in the cavity.

7. The photoreactor according to claim 1, wherein cooling or heating structures, in particular cooling fins or heat transfer channels, are arranged around the outside of the cavity.

8. The photoreactor according to claim 1, wherein the photoreactor is surrounded externally by supporting structures which may optionally comprise devices for connection to further photoreactors, preferably click connections, slide-in connections, screw connections or clamp connections.

9. A photoreaction array comprising a plurality of photoreactors according to claim 1, optionally enclosed by a housing or an enclosure open at the bottom.

10. A method for producing photoreactors according to claim 1, comprising the steps of
a) producing the concentrator and cavity by additive manufacturing processes, in particular 3D printing or extrusion;
b) if the surfaces of the concentrator and/or cavity do not already have a sufficiently high degree of reflection for the incident light due to the production in step a), treating the inner or outer surfaces of the concentrator and cavity by polishing or mirroring, in particular by means of solution deposition, CVD, PVD;
c) optionally inserting a reaction vessel into the cavity.

11. The method according to claim 10, wherein the geometry of the cavity has been determined beforehand, preferably with the aid of an algorithm, by the following steps:
i) providing a cavity with a predetermined geometry, an ellipsoidal or, in particular, a circular cross-section,
ii) specifying deformation parameters which describe at least one deformation with regard to the location on the wall of the cavity, the width and depth of the at least one deformation,
iii) deforming the cavity geometry on the basis of the deformation parameters, in particular at the point of incidence of the primary light beam,
iv) determining the reflection values, in particular the frequency of reflections, of the primary light beam within the cavity, reflection values, and optionally storing the determined values, or determining the functionality of the modified geometry with regard to the photocatalytic efficiency achieved, and optionally storing the determined values,
v-a) repeating steps ii) to iv) several times, wherein in step ii) respectively modified deformation parameters are specified, and comparing the respectively determined reflection values or photocatalytic efficiency with the previously determined reflection values or photocatalytic efficiency values,
v-b) terminating the repetition of steps ii) to iv) as soon as the reflection values or the photocatalytic efficiency in a cavity geometry with one or several deformations has reached a desired quality, preferably when the optimal, in particular highest, frequency of reflections of the primary light beam within the cavity has been achieved,
vi) outputting the determined cavity geometry.

12. A method for optimising the cavity geometry of a photoreactor according to claim 1, preferably with the aid of an algorithm, comprising the steps of:
i) providing a cavity with a predetermined geometry, ellipsoidal or, in particular, preferably circular cross-section,
ii) specifying deformation parameters that describe at least one deformation with regard to the location on the wall of the cavity, the width and depth of the at least one deformation,
iii) deforming the cavity geometry on the basis of the deformation parameters, in particular at the point of incidence of the primary light beam,
iv) determining the reflection values, in particular the frequency of reflections, of the primary light beam within the cavity, reflection values, and optionally storing the determined values, or determining the functionality of the modified geometry with regard to the photocatalytic efficiency achieved, and optionally storing the determined values,
v-a) repeating steps ii) to iv) several times, wherein in step ii) respectively modified deformation parameters are specified, and comparing the respectively determined reflection values or photocatalytic efficiency with the previously determined reflection values or photocatalytic efficiency values,
v-b) terminating the repetition of steps ii) to iv) as soon as the reflection values or the photocatalytic efficiency in a cavity geometry with one or several deformations has reached a desired quality, preferably when the optimal, in particular highest, frequency of reflections of the primary light beam within the cavity has been achieved,
vi) outputting the determined cavity geometry.

13. A use of the photoreactors according to claim 1 for photocatalytic reactions, preferably photosynthesis processes, for use on open surfaces, preferably open terrain surfaces or external building surfaces, in particular on roofs, or for converting CO2 and H2O into chemical energy carriers, or for water treatment.
